(19) United States
(12) Patent Application Publication
(10) Pub. No.: US 2004/0062931 A1
(43) Pub. Date: Apr. 1, 2004

(54) Composite material structure

(76) Inventor: Vladimir Kliatzkin, Kiriat Yam (IL)

Correspondence Address: BLANK ROME LLP, THE FARRAGUT BUILDING SUITE 1000, 900 17TH STREET NW, WASHINGTON, DC, 20006, US

(21) Appl. No.: 10/470,769

(22) PCT Filed: Jan. 23, 2002
(86) PCT No.: PCT/IL02/00067

(30) Foreign Application Priority Data
Feb. 1, 2001 (IL) 141214

(51) Int. Cl. B32B 9/04

(52) U.S. Cl. 428/411.1

(57) ABSTRACT

Improved composite structure comprises threads distributed within disperse matrix. The structure has increased strength by virtue of distance between the points of support of the thread span, which is deliberately selected to be less than the distance corresponding to the critical lengths corresponding to buckling. The structure is suitable for various articles of manufacture requiring improved the strength-to-weight or rigidity-to-weight ratio in various directions.

### FIELD OF THE INVENTION

The invention relates to novel internal structure of parts including composite structure. More particularly, the invention relates to part internal structure, which, on the one hand, achieves adoption of 3D material space distribution and orientation in part to load space distribution. On the other hand this novel, improves specific strength or rigidity as a result of possible minimum contents of binding material and increases the moment of inertia of part without causing buckling damage and decrease in specific weight without strength decrease. As result proposed structure can improve the strength-weight or the rigidity-weight ratio in various directions, both strength and especially rigidity (including buckling) parameters.

The invention further provides producing methods of the proposed part structure, enabling 3-dimensional oriented strength, so as to adopt the products to various purposes. The parts structure can be provided various shapes, with more production efficiency as compared to the sandwich design. Some versions of proposed product are very easily recycled, especially in the mass products—like car body and its elements. The production process is simple and safe.

### BACKGROUND OF THE INVENTION

The present situation with metallic or plastic skin shells type of design may be numerically characterized as follows: 80 to 95% of big and thin shell bodies required in rigidity and resistant to buckling, i.e. most of the material is not efficiently utilized and its strength parameters can't be used. This refers not only to relatively simple bodies in planes or cars etc. The range of complicacy in this case is determined by specific numbers of support per square of the skin cells.

This determined the necessity to develop skins with a high moment of inertia by increasing the thickness of “twin skins” and providing honeycomb sandwich structures. Composite fiberglass products cannot change this situation significantly, since, on the one hand, fiberglass includes a significant component (40-70%) of resin characterized by very low strength, and, on the other, it is very difficult to achieve optimal distribution of strengthening threads in space and directions, especially for local and global buckling.

Significant improvement is achieved by the sandwich honeycomb design. This type of design is used first of all in aeronautic industry, involving extremely high production cost because of tooling requirements. As a rule, the sandwich design products are not recyclable, and they envisage a complicated production process. Alternative use of foam materials, such as corn, alongside with honeycomb design, does not bring about improvement in situation.

Significant improvement is proposed by Israeli patents #75426 of DU PONT DE NEMOURS AND CO and #36522 of FOSTER GRANT CO INC, but these designs are limited by a specific form of cells or profiles, as well as by the choice of material pairs for their matrices, and, what is even more significant, their 3D-volume oriented strength cannot be predetermined.

### SUMMARY OF THE INVENTION

The invention relates to novel internal structure of parts. More particularly, the invention relates to structure, which, on the one hand, achieves adoption material 3D strength of part to load space distribution and, on the other, improves specific strength or rigidity as a result of possible minimum contents of binding material and increases the moment of inertia of part without causing buckling damage and decrease in specific weight. The proposed structure can improve the strength-weight and the rigidity-weight ratio in various 3D oriented directions, both strength and especially rigidity (including buckling).

The invention further provides methodological principles for producing of the parts with proposed structure, enabling 3-dimensional oriented strength, so as to adopt the products to various purposes. The proposed structure of part can be provided various shapes, with more production efficiency as compared to the sandwich design. More from the proposed product is also very easily recycled. The production process is simple and safe.

The novel structure of part comprises a special kind of binding material distribution including foam forms. The strengthening material of parts may be polymeric threads, organic and non-organic filaments, unwoven and woven fabrics etc. Combinations of these strengthening types in one part are possible. The matrix material of part may consist of the same raw materials of strengthening material including combinations as above. The non-solid (including foam) matrix is disposed with predetermined distance between thread segments supports (for foam cells case—wall of cell and strengthening threads intersection are thread support point). The thread diameter meeting requirements of a certain length-to-diameter ratio, with needed cell wall rigidity, which are given a predetermined spatial orientation, and which also meet the requirements related to the parameters indispensable for achievement of 3-dimensional strength parameters distribution. The proposed part internal structure enables decrease in binding material down to 5-10% as compared with 50-60% in conventional composites and, subsequently, brings about decrease simultaneously in weight, cost of material and producing process simplicity.

On the other hand, the proposed part structure material architecture predetermines 3 main embodiments as follows:

1. Low density of binding and strengthening material: density of binding materials may be decreased down to 30-60 kg/m³. The specific weight of plastic strengthening materials may be decreased down to 1000 kg/m³.

2. Optimal distribution (in space disposition and orientation) of strengthening material of part. Simple example of this kind of distribution in the form of the strengthening material peripheral disposition, and the binding material—internal.

3. association of functions—strength of part and it's thermal and acoustic insulation. In this sense the above parameters meet the requirements of bending strength and rigidity of corresponding parts and assemblies.

The novel part structure provides both the internal material structure and the outer decorate skin within same production process.

The binding material can be produced from different polymers including material of strength components.

The range of the pore (cells) size should be from 0.2 mm to 5 mm with adequate average material density from 20 kg/m3 to 150kg/m3 (for polymer version).

One of the objectives of the invention is to achieve an optimum quantitative distribution in space, and orientation of threads. Control of the product may be obtained on the one hand by quantitative methods of determining the form of the strengthening elements and, on the other, by foam matrix state, including foam cells distribution. The desired manner of cells distribution is that based on the “Euler critical length of bar”. Some of the possible cases of thread-binding pairs are as follows:

1. Binding material of low pressure polyethylene and threads with high strength (molecular oriented) polyethylene;

2. Binding material of low-pressure polyethylene and threads from the same material.

In case 1 above, the Young Modulus reaches 1,194,000 kg/cm² and the cell-thread diameter ratio ranges from 10 to 50 under the bulb thickness 1% of the cell diameter.

In case 2 above, the Young Modulus is 30,000 kg/cm² and the cell-thread diameter ratio is from 5 to 10 only.

Advantageous parameters are as follows:

Thickness of the cell wall −10 mk, filaments to matrix material weight ratio is 30:1; overall density 340 kg/cm³ and less. Permissible stress (to elasticity limit) is 300 kg/cm²—3D compression. In this case of structure resistance to buckling (including the total one) is 80 times as much as that of the foam only. This relation is optimal for the above-mentioned 3D compression. For other cases an increased cell size can be used, which brings about decrease of the material density.

Cell size distribution control may be obtained by control of the regime of matrix heating and cooling matching topology of the production process.

The method proposed in the invention may be used for strengthening of several part of the whole product, as follows:

1. Various forms of the ST.M. and/or various forms of compounding.

2. Preliminary insertion of the ST.M. Set before binding material is created (including foaming).

3. Simultaneous injection of ST.M. And formation of binding.

5. Simultaneous placement of ST.M. In mould form and formation of binding.

6. Strength enhancing materials may be inserted as part of the product, in form of short filaments. Length of these filaments may be between 3-10 diameters of cells.

7. Strength enhancing materials may also be inserted in the form of random oriented very long filaments with 100-10,000 cells diameters.

8. Strength enhancing materials may be inserted in the form of various fabric materials. This is efficient for shells, which are subject to internal pressure, and plates, which are subject to various forms of load.

9. Strength enhancing materials may be formed as interconnected layers by means of perpendicular woven threads with desired compression resistance in the corresponding directions. Foaming bulb diameters distribution may correspond that of the threads diameter, distance to outer layer and the connecting threads frequency.

10. Strength enhancing materials may be formed as skeleton components of the part and inserted in the mould before foaming. Matrix material may be created as a result of the reaction between the strength material and the gas flow through the internal cavity of mould. This process may be realized while producing parts of the gas turbine Including stators and turbine blades.

### BRIEF DESCRIPTI N OF THE DRAWINGS

FIG. 1 is a part fragment section view showing structure with single oriented strength threads supported via connection between them.

FIG. 2 illustrates stator or turbine blade structure scheme created from compact unidirectional boron threads packed in mould. These threads are bound with ammonium flow gas under temperature above 800° C. As a result, protected (and connected) layers of boron nitride are created on the threads.

FIG. 3 is a section view showing structure of part with single oriented strength threads supported via binding material of the foam structure.

FIG. 4 is a perspective view part structure with 3D orthogonal oriented expansive threads supported via connection between them.

FIG. 5 is a perspective view of part fragment structure with 3D orthogonal oriented expansive threads supported by foam binding structure.

FIG. 6 is a section view of part fragment internal structure with 3D chaotic expansive threads supported with foam structure cells.

FIG. 7 is a part structure of foam material with predetermined space distribution of cells without insertion of separate strength element.

FIG. 8 is a part structure of foam material with predetermined space distribution of cells without insertion of separate element and with creation of a pseudo-solid permeable or hermetic and (or) decor outer skin from small cells.

FIG. 9 illustrates plates shaped from fabric layers, placed close to the outer surface.

FIG. 10 illustrates fragment of cell shaped from fabric layers, placed close to the outer surface of a thick plate, with separate filaments space distribution. The resin component is foam with special micro-disposition of space-cell size distribution.

FIG. 11 illustrates a part fragment with strength material in the form of fabrics shapes with additionally strengthened threads disposed perpendicular to fabric shapes and foam binding materials with special distribution of foam cells.

### DETAILED DESCRIPTION OF THE PREFERRED EMBODIMENTS

Preferred embodiments of the present invention will hereinafter be described in details with reference to the accompanying drawings.

Embodiment 1.

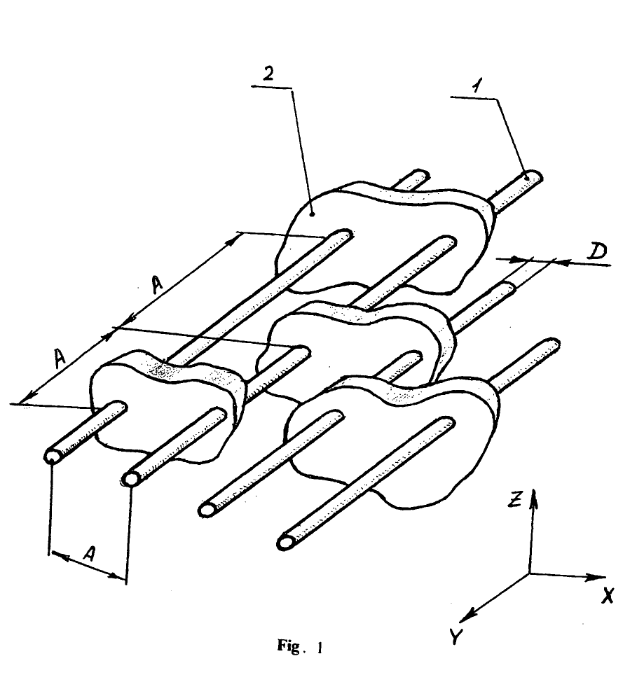

As shown in FIG. 1, the embodiment consists of part fragment with unidirectional oriented strength material threads 1, supported via connection 2 between threads; Distance A between determined connections equals (or is less than) the Euler critical length. Such layout of the material resists compressed forces applied to threads 1 and prevents buckling in the direction of the X axe. I.e. the required cross section (and, consequently, the weight) of threads, to obtain resistance to the compressed force in direction Z, may drastically decrease (up to 5-100 times as much) as compared with solid wall layout at equal resistance to buckling. I.e. resistance to compressed force in the Z direction obtains strength valid for compression of the thread material. In this case additional weight in connections 2 may be 5-20 times as small as that of solid binding proportional connection to the critical length of threads, and represent additional reserve of the weight decrease.

Embodiment 2.

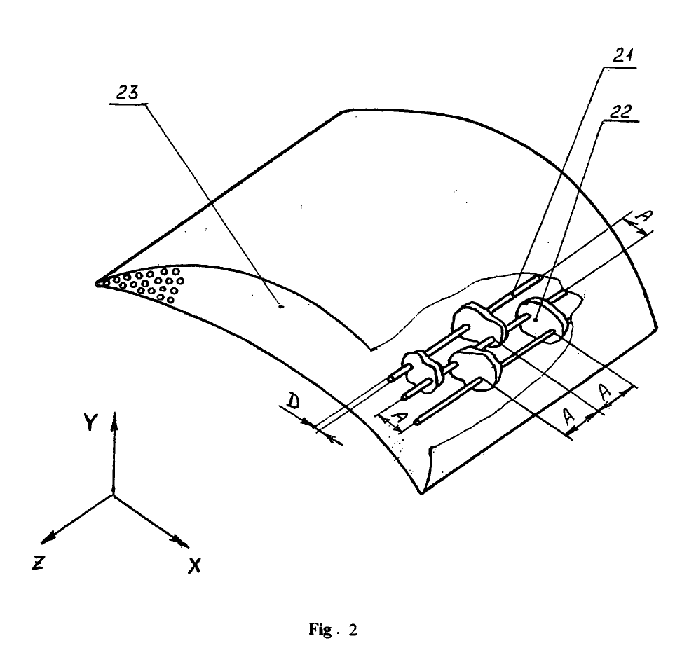

FIG. 2 presents part fragment structure created from compact unidirectional mould-packed boron threads 21. Threads 21 connected with connections 22 are created by means of ammonium supply at temperature exceeding 800° C. Subsequently, the threads connected between them and on the outer surface 23 created a protecting layer of boron nitride. Such layout must resist the tension force (centrifugal) in the Z direction, bending (gas pressure) in X&Y direction and, as a result of the gas forces impact, the possible buckling of separate outer threads on the side opposite to the gas pressure direction. Preference of such part structure for this application (turbine blades) may be formulated as follows:

1. Unidirectional boron can resist more forces at high temperature (for boron protected with boron nitride) of 1150° C., i.e. up to 250-300° C. Increase in the turbine blades temperature results in increase of the turbine efficiency up to 20% as compared with the current value for jets engines.

2. Protection of the outer blade surface by means of its hardening can improve the wear resistance of the blade.

3. Decrease in the weight of the blades 4 times as much (as compares with Nickel and Cobalt alloys) and simultaneous decrease in the axial Z-direction load brings about decrease in the stress of blades, especially in its connection to the disk.

4. Decrease in the centrifugal force causes decrease in the turbine disk weight.

5. The proposed technology enables production of blades producing directly from the described formation and without tooling.

6. This architecture of turbine (or stator) blade must prevent brittleness of the material, which is characteristic of ceramic blades. The reason is that strong metallic boron impacts elasticity to the material. On the other hand, metallic boron and boron nitride have the same coefficient of thermo-expansion.

The same results may be obtained applying this technology for production of jet stator and compressor blades and stator. For compressor blade and stator, the boron nitride coating may be also used by boron carbide.

Embodiment 3

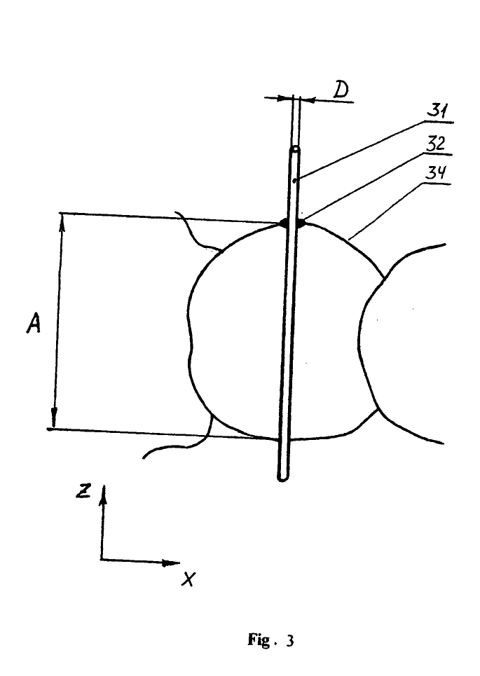

FIG. 3 is a part fragment section view showing structure with single oriented strength threads supported via binding material of foam structure. As shown in FIG. 3, embodiment consists of unidirectional strength material threads 31 supported via connection 32, and shell wall 34 filled with gas between threads. Distance A between the determined connections equals (or is less than) the critical (Euler) length for this kind of material—Modulus Young and thread diameter D. Such a layout resists the compressed forces applied to threads 31 and prevents buckling in the direction of axes X and V. I.e. the required cross section (and, consequently, the weight) of threads for resisting compressed force in the Z direction may decrease sharply (5-100 times as much) as compared with solid wall layout equally resistant to buckling. I.e. resistance to the compressed force in the Z direction obtains compression strength for the thread material. In this case additional weight connections 32 may be 5-20 times less than that of the proportional connection length of solid bindings as related to the critical length of threads, representing decrease in the additional weight reserve.

This kind of the material layout may be very applicative in cases when mechanical strength must be associated with noise and (or) thermo insulation and with the space of energy absorption (safety elements).

Embodiment 4

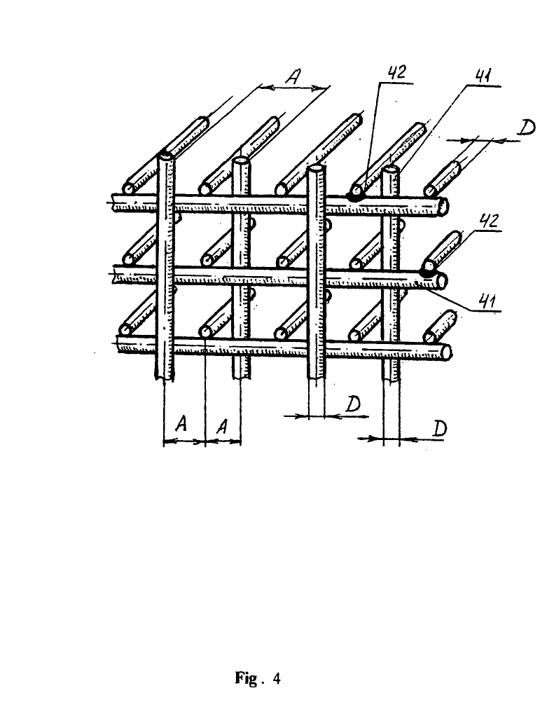

FIG. 4 is a part fragment perspective view structure with 3D orthogonal oriented expansive threads supported via connection between them. As shown in FIG. 4, embodiment consists of part fragment with space oriented strength material threads 41, supported via connection 42 between threads. Distance A between determined connections equals (or is less than) the critical (Euler) length. This material layout resists the compressed forces applied to threads 41 and prevents buckling in the orthogonal direction. I.e. the required cross section (and, as a result, the weight) of threads for resisting compressed force applied to any thread axe may decrease sharply (up to 5-100 times as much) as compared with solid wall layout equally resistant to buckling. I.e. resistance to compressed force in any direction obtains strength of compression for thread material. In this case additional weight connections 42 may be 5-20 times less than those of solid binding proportional connection lengths as related to the critical length of threads, representing reserve of the weight decrease.

Embodiment 5

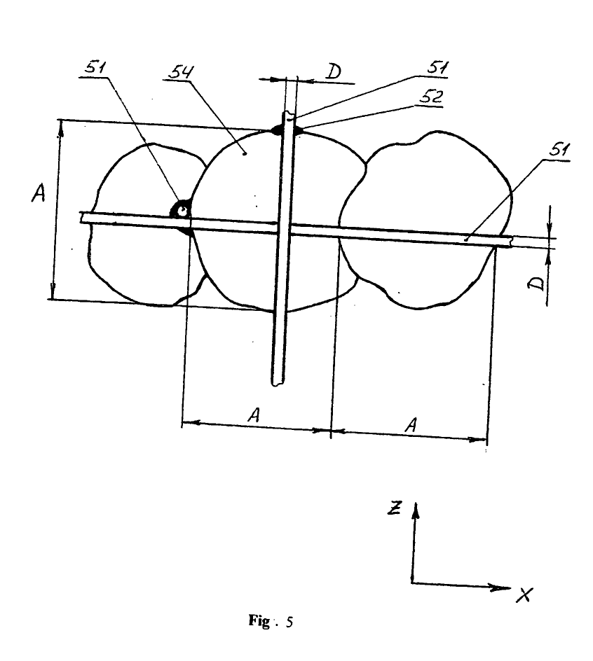

FIG. 5 is a perspective view structure with 3D orthogonal oriented expansive threads supported by foam binding structure. As shown in FIG. 51, embodiment consists of space including orthogonal oriented strength material threads 51, supported via connection 52 and shell wall 54 filled with gas between threads. Distance A between the determined connections equals (or is less than) the critical (Euler) length for this kind of material—Modulus Young and treads diameter D. This material layout resists the compressed forces applied to threads 51 and prevents buckling in orthogonal directions. I.e. the required cross section (and, as a result, the weight) of threads for resisting compressed force in the applied force direction may be decrease sharply (up to 5-100 times as much) as compared with solid wall layout at equal resistance to buckling. I.e. resistance to the compressed force in the direction of the applied force obtains the strength of compression for thread material. In this case additional weight connections 52 may be 5-20 times less than those of solid binding proportional connection lengths as related to the critical length of threads, representing reserve of the weight decrease.

This kind of the material layout may be very applicative in cases when mechanical strength must be associated with noise and (or) thermo insulation and with the space of energy absorption (safety elements).

Embodiment 6

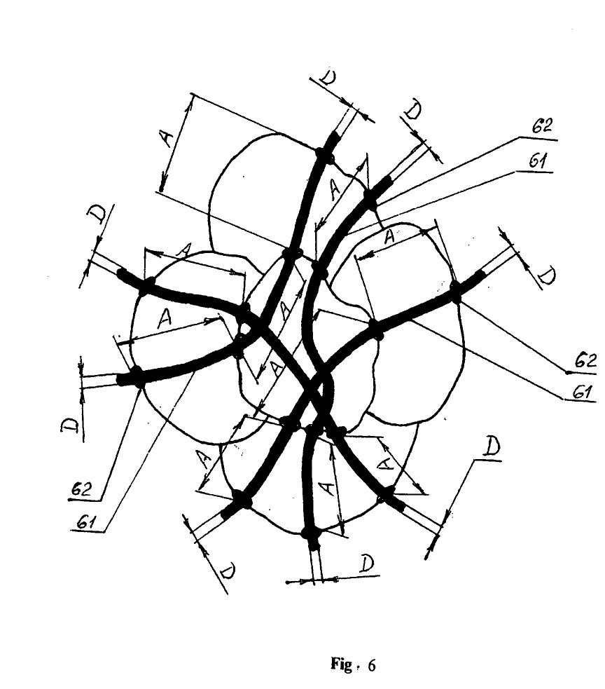

FIG. 6 is a section view of part fragment internal structure 3D of chaotically oriented expansive threads supported by foam structure cells. As shown in FIG. 6, the embodiment consists of space chaotic displacement strength material threads 61, supported via connection 62 between threads by foam shell walls. Distance A between the determined connections equals (or is less than) the critical (Euler) length. Such material layout resists the compressed forces at the bending moment applied to any side of the assembly part and prevents local buckling on the moment surface. I.e. the layout enables building of parts of high moments of inertia and of the resistance moment with a very thin outer skin, and prevents local buckling of the skin. The required cross section (and, as a result, the weight) of threads for resisting the compressed force applied to any thread axe may decrease sharply (up to 5-100 times as much) as compared with solid wall layout equally resistant to buckling. I.e. resistance to the bending moment in any direction obtains strength of compression and tension of thread material. In this case additional weight connections 62 and foam cells may be 5-20 times less than those of the solid binding proportional connection lengths related to the critical length of the threads, representing weight reserve decrease.

In principle this structure of shells parts, big plates etc, more than others, describes similarity to conventional sandwich materials. The main differences may be formulated as follows:

1. Minimum thickness of part walls of the outer solid or pseudo-solid cell or plate, unlimited as far as buckling is concerned.

2. Space between outer rigid elements may have control rigidity, including rigidity increasing in the peripheral direction—optimal distribution.

3. Producing of the parts in a single production process with no need of further mechanical tooling.

4. The possibility of producing parts, consist strength and binding materials from the same raw materials, enabling simple and efficient recycling of product.

Embodiment 7.

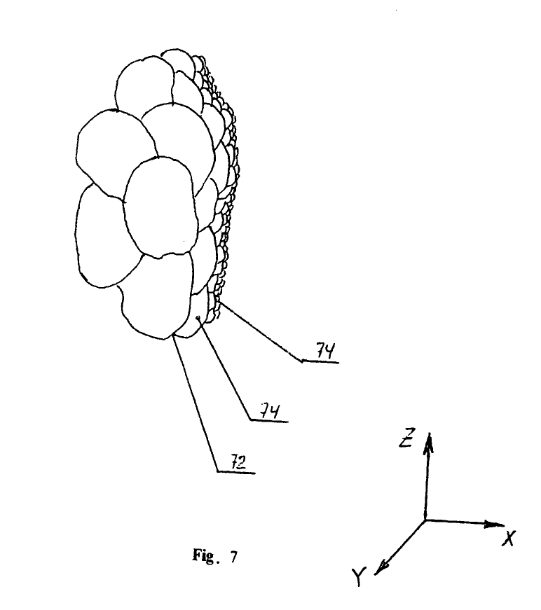

FIG. 7 is a part composite structure of foam material with predetermnined space distribution of cells without insertion of separate strength elements.

FIG. 7 indicates a sectional view of the part fragment and explains the basic structural principles of the proposed part structure. The main principle of this type of structure design is use of binding and strength elements as one component. In principal this layout resembles very much the bone architecture of animals and people.

Strength element is any foam cell 74. Contact points and divisions between separate cells are connection points 72. The main problem of this kind of layout is that for the time being, no form of the physical-chemical parameters enables to create strength materials in the form of foam cells. Any usable strength material has a linear structure, including filament threads. As cell wall, the foam material does not provide strength, but increases the moment of inertia of the part section. In most cases cell sizes 74 show optimal distribution (decrease of the cell size at the peripheral surface). These cells may be open or closed, permeable or transparent. When produced, the cells may be controlled via control of the mould wall heating and cooling temperature during the formation process.

Embodiment 8

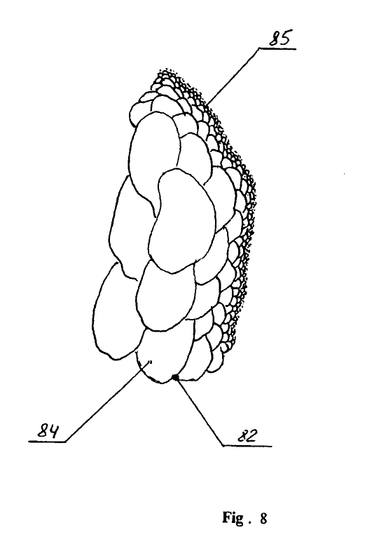

FIG. 8 is a part fragment structure of foam material with predetermined space distribution similar to that described in Embodiment 7. This structure is specific for the size of its outer layer cells, which create pseudo-solid permeable or hermetic outer skin from small cells similar to the bone of animal (or people) architecture.

Embodiment 9

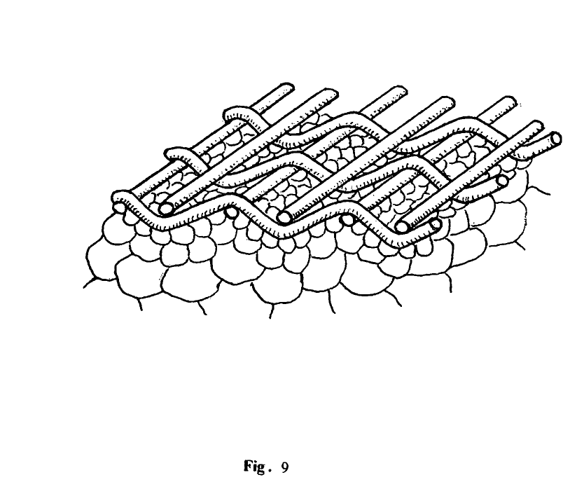

FIG. 9 illustrates a fragment of parts shaped in free surface including plates via shaped fabric layers 95, produced from threads with increasing strength and rigidity disposed on the outer surface and providing a high moment of inertia where its strength and rigidity parameters may be realized as much as possible, and, as a result, determine strength and rigidity. The resin component is presented in the form of foam cells 94 connected in the connection points 92, which were created in the foam binding production process.

Minimal anti-buckling size A is determined by the size of cells and their distribution. At the same time strength is determined exclude exclusively by thickness and strength of the outer (fabric) layer.

Embodiment 10

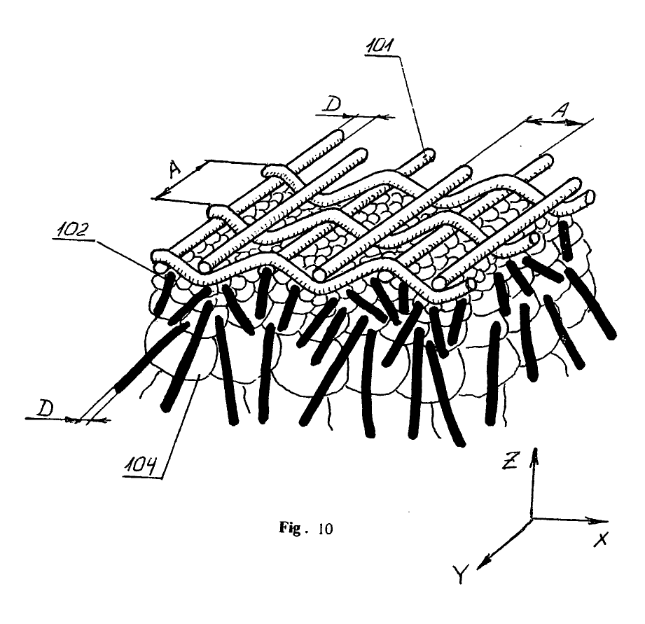

FIG. 10 illustrates a fragment of parts shaped on the free surface including plates via shaped fabric layers 105 produced from threads or fabrics (woven or not woven), with increasing strength and rigidity disposed on the outer surface, providing a high moment of inertia where its strength and rigidity parameters may be realized as much as possible and, as a result, determining strength and rigidity. Fabric supporting part is in the form of foam cells 104 connected in connection points 102, created in the binding foam production process. Additional anti-buckling strength is obtained via orthogonal filaments with distance A between them. Lengths of filaments B are determined by the size of cells and their distribution. Minimal anti-buckling sizes A and B determine buckling resistance of the outer fabric layer. Strength of the part (or its fragment) is determined exclusively by thickness and strength of the outer (fabric) layer.

Embodiment 11

FIG. 11 illustrates a part structure with strength material in the form of aerodynamic foil, which consists of two free forms of opposite shapes (including plate) 115 assembled via connecting threads 102 with distance A between them. Supported systems as executed in the form of foams binding materials with space distributions of the foam cells. This distribution must correspond to the following conditions. In the outer zone, the relative cell diameter D1 must conform the requirements of buckling of the fabric layer thread, i.e. its diameter must be less than the critical Eller length of the thread. In the inner zone, the cell diameter must correspond to the Eller critical length of connecting thread D2, which is approximately orthogonal to outer surfaces. On the other hand, this size must be adequate to the distance between connecting threads A2.

### EXAMPLES OF USE AND REALIZATION OF THE PART INTERNAL STRUCTURE.

### Example 1

| | |
|---|---|
| Part application | - Monoblock Car Body (Sedan 4150 mm 2500 mm |
| | wheel base, 1350 mm track. |
| Loading cases (including impact) | 1. Torsion - 1000 kgm (on the Wheel base 2500 mm) |
| | 2. Bending - Max moment 1250 kgm. |
| | 3. Compression in X - direction 1900 kg |
| | 4. Compression in Y - direction 1200 kg |
| | 5. Compression in +Z direction 4000 kg |
| | 6. Compression in −Z direction 1600 kg |
| Additional conditions | 1. Very significant permeability and surface quality. |
| | 2. Part including noise and thermo insulation. |
| Strength and rigidity | 1. Shapes developed and formed on the outer fabric |
| | Layers, connected via the orthogonal to the Layers |
| | Threads. |
| | 2. Fabric - woven X-direction (warp) 4ends/cm, Y- |
| | Directions (weft) 2ends/cm, Z-directions (connection |
| | Threads 1 ends per 10 cm) |
| | 3. Threads thickness 0.5 mm. |
| | 4. Common fabric square 25 m² |
| | 5. Specific weight of fabric - 95 g/m2 |
| | 6. Strength material - Molecular oriented Polyethylene |
| | 7. Common weight of strength material 2.33 kg |
| | 8. Strength material Tensile strength 5 Gpa |
| Support binding and | 1. Support -Binding foam material volume - 1.7 m³ |
| Decorative layer | 2. Specific weight of foam material - 40 kg/m3 |
| | 3. Foam support-binding material weight - 68 kg |
| | 4. Decorative film thickness 0.2 mm |
| | 5. Decorative film weight - 4.75 kg |

Overall weight of the body 75.1 kg excluding doors, windows, and suspensions, Thermo isolation and painting including seating, noise and connection systems.

### Example 2

| | |
|---|---|
| Part application | - Monoblock refrigerator body (Volume 5001 |
| | 740 × 620 × 1750 mm). |
| Loading cases (including impact) | one. Compression in Z - direction 100 kg |
| Additional conditions | 1. Permeability and surface quality very significant. |
| | 2. Part including noise and thermo insulation. |
| Strength and rigidity | 1. Short threads and filaments of polypropylene |
| | Sprayed by means of a gun accompanied with |
| | Binding material into matrix with variable density |
| | Distributions. |
| | Distribution of threads near walls (deep 10 mm)-5 |
| | ends/cm²), distribution in centers of wall interval |
| | 20 mm (1 end/1 cm²) |
| | 2. Thread thickness 0.5 mm. |
| | 3. Specific weight of threads - 0.95 g/m2 |
| | 4. Strength material - Polypropylene threads |
| | 5. Total weight of strength material 1.02 kg |
| | 6. Strength material Tensile strength 0.8 Gpa |
| Support binding and | 1. Support-Binding foam material volume - 0.159 m3 |
| Decorative layer | 2. Specific weight of foam material - 30 kg/m3 |
| | 3. Foam support-binding material weight - 1.85 kg |
| | 4. Decorative film thickness 0.2 mm |
| | 5. Decorative film weight - 1.89 |
| Total weight of the body | 4.76 kg excluding doors, suspensions, including thermo |
| | insulation and decorative layer. |

### Example 3

| | |
|---|---|
| Part application | Turbine blade (chord 45 mm; lenght 120 mm; |
| | Height 15%; thickness 7%, twist 35 deg |
| Loading cases | 1.Centrifugal acceleration 11250 g in Z-direction; |
| | 2.Bending - Max moment 1.25 kgm in X,Y-direction. |
| | 3.Torsion relation to X - direction 0.9 kgm |
| | 4.Vibration with value 50% from bending moment |
| | With frequency 6740 Hz |
| | 5.Temperature 1470° K |
| | 6.Oxygen concentration 7% |
| Additional conditions | 1.Permeability and surface quality very significant. |
| Strength and rigidity | 1.Axial (in Z-direction) filaments disposed in |
| | Z-direction at full length of the blade |
| | 2.Boron threads with high-density packing to contact |
| | Under any blade length. |
| | 3.Threads thickness 0.5 mm. |
| | 4.Specific weight of the material (Boron) - 2.34 g/cm3 |
| | 5.Strength material - Boron |
| | 6.Total weight of strength material 12.33 g |
| | 7.Strength material tensile strength 7 Gpa |
| Supporting binding | 1.Specific weight of support binding material - |
| and protection layer | 2.34 g/cm3 |
| | 2.Support-binding material weight 6.14g |
| | 3.Aerodynamic protection layer thickness 0.15 mm |
| | 4.Protection layer weight 3.51 g |
| Overall weight of blade | 20.79 g excluding lock |

1. A part structure consisting of strength materials in the form of threads, which distance between points of supports of the thread span less than those of the critical lengths of buckling.

2. A part structure according to claim 1 where supporting functions utilize the walls of gas bulb of the foam binding material.

3. A part structure according to claims 1 or 2 where the strengthening material has a 3-dimensional orientated set of threads.

4. A part structure according to claims 1 to 3 where the strengthening material is executed in the form of elements consisting specially oriented elements from fabrics.

5. A part structure according to claims 1 to 4 where strengthening material has an irregular distance between separate threads.

6. A part structure according to claims 1 to 5 where the foam binding materials have an irregular foam form supported by special distribution of bulb diameters and bulb walls thickness.

7. A part structure according to claims 1 to 6 where the set of strengthening elements includes different forms of fabrics, single threads, chaotic bunches.

8. A part structure according to claims 1 to 7 where the strengthening element, for example different form those of the fiber threads and the binding support materials, includes foam of the same fiber.

9. A part structure according to claims 1 to 7 where the strengthening element, for example difference form those of the oriented polyethylene threads and the support materials, includes foam of the low pressure polyethylene.

10. A part structure according to claims 1 to 7 where the strengthening element, for example different form those of the oriented polyethylene threads and the support materials, includes foam of the high pressure polyethylene.

11. A part structure according to claims 1 to 7 where the strengthening elements are metallic boron threads and the binding supporting materials are ceramics, carbides or nitric boron materials.

12. A part structure according to claims 1-10 consisting of the outer cell from micro-sized closed bulbs creating a permeable outer layer.

13. A part structure according to claims 1-10 consisting of a strengthening material in the form of space free shape(including flate) providing connection between them via perpendicular threads.

14. A method of part producing 1 according to any one of claims 1-11, comprising introduction into a mould of a fitting reinforcing foaming material, and providing foaming until the desired foam reinforced by the above reinforcing material is formed.

15. A method of part producing via forming in the mould with temperature controlled walls according to claim 14. The wall temperature is determined by distribution of foam cavern sizes in required directions.

16. A material according to claims 1-15, which provides a decrease in compressing stresses via pretension of threads in his axle in directions.
